(19) United States
(12) Patent Application Publication
(10) Pub. No.: US 2014/0152416 A1
(43) Pub. Date: Jun. 5, 2014

(54) MAGNETIC CORE, METHOD AND DEVICE FOR ITS PRODUCTION AND USE OF SUCH A MAGNETIC CORE

(71) Applicant: Vacuumschmelze GmbH & Co. KG, Hanau (DE)

(72) Inventors: Giselher HERZER, Bruchkoebel (DE); Christian POLAK, Blankenbach (DE); Klaus REICHERT, Offenbach (DE)

(73) Assignee: Vacuumschmelze GmbH & Co. KG, Hanau (DE)

(21) Appl. No.: 14/050,806

(22) Filed: Oct. 10, 2013

(30) Foreign Application Priority Data
Oct. 12, 2012 (DE) 10 2012 218 657.3

(51) Int. Cl. H01F 1/40

(52) U.S. Cl. CPC H01F 1/40
USPC 336/233; 335/297

(57) ABSTRACT

A magnetic core, such as for an interphase transformer, made of a nanocrystalline alloy, which consists of

Fe_{100-a-b-c-d-x-y-z}CuₐNb_{b}M_{c}T_{d}SiₓB_{y}Z_{z} and up to 1 at. % of impurities, whereby M is one or more of the elements Mo, Ta or Zr; T is one or more of the elements V, Cr, Co or Ni; and Z is one or more of the elements C, P or Ge, and
0 at. %≦a<1.5 at. %,
0 at. %≦b<4 at. %,
0 at. %≦c<4 at. %,
0 at. %≦d<5 at. %,
12 at. %<x<18 at. %,
5 at. %<y<12 at. %, and
0 at. %≦z<2 at. %,
   the core having a saturation magnetostriction of <2 ppm and a permeability between 100 and 1,500, wherein the alloy has been exposed to a heat treatment at a temperature between 450 and 750° C. under a tensile stress between 30 and 500 MPa.

This application claims benefit under 35 U.S.C. §119 of the filing date of German patent application DE 10 2012 218 657.3, filed Oct. 12, 2012, the entire contents of which is incorporated herein by reference for all purposes.

### BACKGROUND

1. Field

Disclosed herein is a magnetic core, in particular for an interphase reactor, a method and a device for the production of such a magnetic core, and a method of use of such a magnetic core.

2. Description of the Related Art

Interphase reactors, which are also referred to as interphase transformers, are traditionally used in low-frequency ac technology (for example, 50 Hz technology) for coupling multipolar rectifiers. In this case, they are usually designed with flattened FeSi cores, which results in relatively heavy and large designs. The latter is disadvantageous for certain applications, such as, for example, in aeronautics, where a design that is as lightweight as possible is required. One way to save weight and reduce volume is to increase the operating frequency in the frequency range of several kHz up to several 10 KHz. With the increase in frequency, however, losses also increase. An example of an interphase transformer, which is suitable, for example, for aircraft, is described in US 2010/0008112 A1. There, it is also explained that the heating of the interphase transformer poses a problem because of the power loss and cooling of the device.

It is not possible to use common interphase transformers in engine controllers in aircraft, since they would become much too hot due to the increased operating frequencies. As a result thereof, and since the permeability of the cores of these interphase transformers that are used has high sample scattering as well as a strong temperature dependency, the other inductivities, such as current-compensated and linear interference restrictors, had to be oversized by a multiple in order to withstand the high imbalance currents. This results in a five- to ten-fold increase in weight of the cores that are used.

The core can be a magnetic core, in particular annular belt cores that are wound from strips of soft-magnetic material. For the production of soft-magnetic material, various production methods and the related production devices are known. The known production devices are generally designed as continuous annealing units and make possible a heat treatment of quickly-congealing magnetic material (“belt material,” below). The quickly-congealed magnetic material is produced by means of a casting method and then wound into a roll in order to be introduced as a continuous belt into the continuous annealing unit and then processed by the latter to form soft-magnetic material. Within the framework of the processing, the material is heat-treated and simultaneously exposed to a magnetic field in order to obtain desired magnetic properties of the belt.

### SUMMARY

There remains a need to eliminate the drawbacks according to the state of the art. In particular, this need is satisfied by a magnetic core as disclosed herein which allows the production of interphase transformers that have small losses at operating frequencies of up to 10 kHz or more, tolerate peak currents of more than 100 A without becoming saturated, and can be operated at temperatures of up to 200° C.

A magnetic core is provided, for example for use in an interphase transformer, from a nanocrystalline alloy, which has Fe_{100-a-b-c-d-x-y-z}CuₐNb_{b}M_{c}T_{d}SiₓB_{y}Z_{z} and up to 1 at. % of impurities, whereby M is one or more of the elements Mo, Ta or Zr; T is one or more of the elements V, Cr, Co or Ni; and Z is one or more of the elements C, P or Ge, and

0 at. %≦a<1.5 at. %,

0 at. %≦b<4 at. %, for example: 0 at. %≦b<3.5 at. %,

0 at. %≦c<4 at. %, for example: 0 at. %≦c<3 at. %,

0 at. %≦d<5 at. %,

12 at. %<x<18 at. %,: 12 at. %<x<17 at. %,

5 at. %<y<12 at. %, for example, 5 at. %<y<9 at. %, and

0 at. %≦z<2 at. %,

whereby the magnetic core has a saturation magnetostriction of less than 2 ppm and a permeability of between 100 and 1,500, and whereby the alloy has been exposed to a heat treatment at a heat-treatment temperature of between 450 and 750° C. under a tensile stress of between 30 and 500 MPa. For example, the heat-treatment temperatures for a content of Niobium (Nb) equal to 0 at. % can lie between 500° C. and 570° C., for Nb equal to 0.5 at. % can lie between 510° C. and 620° C., for Nb=1.5 at. % can lie between 535° C. and 670° C., and for Nb=3 at. % can lie between 580° C. and 720° C.

It has turned out, surprisingly enough, that such a magnetic core allows operating temperatures in interphase transformers of 150 to 200° C. and even still higher operating temperatures. The improved magnetic cores further make it possible to make available interphase transformers with small losses at operating frequencies of up to 10 kHz or more, which, moreover, tolerate peak currents of several 100 A without becoming saturated. Instead of the term “magnetic core,” the term “core” is also used below.

The use of alloys with reduced niobium content has the advantage that the latter have a considerably higher saturation polarization, which results in a weight- and production cost reduction in the case of the magnetic core; i.e., lower raw material costs and a smaller magnetic core result.

The niobium content can be set at at most 4 at. % in order to keep the costs of the improved magnetic core as low as possible. A silicon content of at least 12 at. % is advantageous in order to obtain a magnetostriction that is less than 2 ppm.

According to one embodiment, the alloy has a nanocrystalline structure with a crystalline phase that is embedded in an amorphous matrix, whereby the crystalline phase consists of bcc Fe—Si and has a volume proportion of greater than 50%. The term “bcc” (English: “body centered cubic”) in this case characterizes a cubic inward-centered crystal lattice. Preferably, the grains of the crystalline phase have a grain diameter of less than 100 nm, for example less than 50 nm. Owing to this structure, a low saturation magnetostriction at high saturation polarization is achieved.

The saturation magnetization of the improved magnetic core is greater than 1.1 Tesla in one embodiment. Owing to an increase in the saturation magnetization, the magnetic core can be further scaled-down, and its weight can be reduced. This is possible since because of the higher saturation, the permeability can be increased without the core going into saturation prematurely. In addition to the savings in weight, the improved magnetic core can also be produced more economically because of the smaller Nb content.

In another embodiment, the nanocrystalline alloy has an anisotropy field strength, in which it is saturated, of at least 600 A/m.

The magnetic core can have magnetization reversal losses of less than 20 W/kg at an excitation frequency of 5 kHz and an induction stroke of 0.5 T.

In a preferred embodiment of the magnetic core, the permeability increases less than 50%, relative to its value at room temperature, over a temperature range from room temperature) (20° to 150° C. In a like manner, in this temperature range, the anisotropy field strength decreases less than 50%, relative to its value at room temperature. The value at room temperature is also referred to as the room temperature value.

For example, over a temperature range from room temperature to 200° C., the permeability can increase less than 30%, relative to its value at room temperature. In a like manner, in this temperature range, the anisotropy field strength decreases less than 30%, relative to its value at room temperature. This can be achieved by means of a nanocrystalline alloy, which contains at most 4 at. %, for example below 2 at. %, of niobium. Such a low proportion of niobium furthermore reduces the costs for the production of the magnetic core.

The magnetic core can have a saturation magnetostriction of less than 1 ppm. This can be achieved by the silicon proportion x of the nanocrystalline alloy lying in a range of 15 at. %≦x≦16.5 at. %.

The nanocrystalline alloy can also have at least one of the following properties:
A nanocrystalline structure, in which at least 50% by volume of the grains have a mean size (diameter) of less than 100 nm,
A hysteresis loop with a central linear part,
A remanence ratio, Jᵣ/Jₛ, <0.1, and
A ratio of coercive field strength H_{c}, to anisotropy field strength Hₐ, of less than or equal to 10%.

For the production of the magnetic core, a belt-shaped material can be used. The belt-shaped material can be an alloy that has the same components as the nanocrystalline alloy in the same proportions, but it is an amorphous material. In addition, in its magnetic properties, the belt-shaped material differs from the desired nanocrystalline alloy. The magnetic properties are then set by, for example, heat treatment under the action of a tensile force, by which the belt-shaped material is converted into a soft-magnetic strip material.

The belt shape makes possible not only the production of the nanocrystalline alloy under tensile stress in a continuous furnace, but rather also the production of a magnetic core with any number of windings. The belt-shaped material is obtained by, for example, a casting method.

The permeability of the nanocrystalline alloy based on iron, which is to be, for example, between 100 and 1,500, can be approximately determined by selection of the tensile stress in the case of heat treatment. The tensile stress, for example, lies in a range of 30 to 500 MPa. In this way, belts can be produced with a permeability within the entire permeability range of μ=100 to μ=1,500.

The lower the permeability, the higher the electrical currents can be by the windings of the magnetic core, without saturating the material. Also, with the same permeability, these currents can be higher, the higher the saturation polarization, Jₛ, of the material. By contrast, the inductivity of the magnetic core increases with the permeability and the size. To construct the magnetic cores with higher inductivity and higher current tolerance at the same time, it is therefore advantageous to use alloys with higher saturation polarization.

The nanocrystalline alloy that is based on iron is obtained in the form of a soft-magnetic strip material that consists of a belt-shaped material. The material is thus prepared as a belt before it is subjected to the heat treatment under the action of a tensile force while the strip material is obtained. The strip material can have a thickness of 10 μm to 50 μm. This thickness makes possible the winding of an improved magnetic core with a high number of windings, which at the same time has a small outside diameter.

The soft-magnetic strip material can also be coated with an insulating layer in order to insulate the windings of the magnetic core electrically from one another. The layer can be, for example, a polymer layer, a powder coating, or a ceramic layer. Such an insulating layer is also referred to as fixing.

Because of the heat treatment under tensile stress, a magnetic hysteresis loop with a central linear part, a remanence ratio of less than 0.1, and a coercive field strength of less than 10% of the anisotropy field result. Thus, low magnetization reversal losses and a permeability that within broad limits is independent of the applied magnetic field or the preliminary magnetization in the linear central part of the hysteresis loop are associated therewith.

Hereinafter, the central part of the hysteresis loop is defined as the part of the hysteresis loop that lies between the anisotropy field strength points that characterize the transition into saturation. A linear part of this central part of the hysteresis loop is defined hereinafter by a non-linearity factor NL of less than 3%, whereby the non-linearity factor is calculated as follows:

NL (in %)=100(δJᵤₚ+δJ_{down})/(2Js)

In this case, δJᵤₚ or δJ_{down} refer to the standard deviation of the magnetization of a compensating line through the up or down branch of the hysteresis loop between magnetization values of ±75% of the saturation polarization Jₛ.

For example, the remanence ratio of alloy A is less than 0.05. The hysteresis loop of the nanocrystalline alloy is thus still more linear or more flat. In another embodiment, the ratio of the coercive field strength to the anisotropy field strength is less than 5%. Also, in this embodiment, the hysteresis loop is still more linear, so that the magnetization reversal losses are still lower. Especially linear loops are produced in this case in the permeability range μ=100 to 1,500.

The prepared belt-shaped material is heat-treated under tensile stress in order to produce the desired magnetic properties. The nanocrystalline alloy, i.e., the finished heat-treated belt, is thus also characterized by a structure that is produced by its production method. In one embodiment, the crystallites have a mean size of, for example, 20 to 25 nm (Nb=1.5 at. %) or 10 to 15 nm (Nb=3 at. %) and a remanent expansion in the belt-length direction of between, for example, 0.01%-0.02% and 0.5%, which is proportional to the tensile stress applied in the heat treatment. The crystalline grains can have an expansion of at least 0.01%-0.02% in a preferred direction.

A method for the production of the improved magnetic core comprises the steps:

preparation of an alloy as a belt-shaped material, whereby the alloy consists of Fe_{100-a-b-c-d-x-y-z}CuₐNb_{b}M_{c}T_{d}SiₓB_{y}Z_{z} and up to 1 at. % of impurities, whereby M is one or more of the elements Mo, Ta or Zr; T is one or more of the elements V, Cr, Co or Ni, and Z is one or more of the elements C, P or Ge, and

0 at. %≦a<1.5 at. %,

0 at. %≦b<4 at. %, for example: 0 at. %≦b<3.5 at. %,

0 at. %≦c<4 at. %, for example: 0 at. %≦c<3 at. %,

0 at. %≦d<5 at. %,

12 at. %<x<18 at. %, for example: 12 at. %<x<17 at. %,

5 at. %<y<12 at. %, for example, 5 at. %<y<9 at. %, and

0 at. %≦z<2 at. %;

heat treatment of the belt-shaped material at a heat-treatment temperature of between 450 and 750° C., whereby, for example, the heat-treatment temperature for a content of niobium (Nb) equal to 0 at. % can lie between 500° C. and 570° C., for Nb equal to 0.5 at. % can lie between 510° C. and 620° C., for Nb=1.5 at. % can lie between 535° C. and 670° C., and for Nb=3 at. % can lie between 580° C. and 720° C.;

loading the heat-treated belt-shaped material with a tensile force in the longitudinal direction of the belt-shaped material in order to produce a tensile stress of between 30 MPa and 500 MPa in the belt-shaped material, while a soft-magnetic strip material is obtained, whereby to produce the soft-magnetic strip material from the belt-shaped material, in addition the following is provided:

determination of at least one magnetic measurement value of the soft-magnetic strip material being produced, and

adjustment of the tensile force for setting the tensile stress in reaction to the determined magnetic measurement value; and

winding up at least one defined section of the soft-magnetic strip material being produced to produce the magnetic core.

The sequence of the steps can also vary depending on the application.

Thus, a prepared belt-shaped material, in particular an amorphous belt-shaped material, is provided, which is subjected to a heat treatment in a subsequent step. Then, the belt-shaped material is loaded with the described tensile force simultaneously to the heat treatment and/or subsequently thereto in order to produce a tensile stress in the belt-shaped material. Via the tensile stress that is present, a structural change of the material and thus an anisotropy, for example a transverse anisotropy, can be induced in the belt-shaped material. For example, the tensile stress is adapted in such a way that the soft-magnetic strip material that is produced by means of the method has a pronounced flat hysteresis loop with a defined permeability μ in the tensile stress direction. The loading with the tensile force (for example at least 10 MPa-20 MPa) is done simultaneously to the heat treatment.

As already described above, in this connection, the induced anisotropy is proportional to the tensile stress that is introduced, whereby the permeability depends on the anisotropy. A graphic depiction and detailed description of the relationships are given in FIGS. 3a and 3b and the related description.

By means of the described steps, a soft-magnetic strip material is produced with defined magnetic properties or a changed structure from the belt-shaped material and then subjected to a measurement to determine one or more magnetic measurement values. The latter give indications on the magnetic properties of the strip material that is produced, for example for a magnetic characterization of the soft-magnetic strip material that is produced. An exemplary list of magnetic measurement values that can be determined is further provided below.

With knowledge of the at least one magnetic measurement value, the described adjustment of the tensile force can then be carried out in order to set the tensile stress to a desired value. Thus, by means of the tensile force, the tensile stress is varied, whereby the adjustment of the tensile force is carried out based on the at least one magnetic measurement value that is determined.

According to one embodiment, in the step of the adjustment of the tensile force, the tensile force is varied in such a way that the tensile stress is essentially kept constant in the longitudinal direction of the belt-shaped material at least in places in the longitudinal direction. Accordingly, the tensile force is changed in such a way that the tensile stress that prevails locally in the belt-shaped material can be kept constant. In this way, influencing of the local tensile stress by the local cross-sectional surface area that fluctuates, due to production-related factors, over the longitudinal course of the belt-shaped material, can be compensated for in such a way that a fluctuation of the related tensile stress associated therewith is essentially prevented, as was the case when only a constant tensile force was to be applied.

Consequently, in the continuous belt-shaped material, in the case of the constant tensile stress, a corresponding constant anisotropy K_{U} can be induced, which produces a permeability μ that is also constant. In addition, still other parameters are known, which can influence and change an induced anisotropy in such a production method; these include, for example, the heat-treatment temperature, the throughput speed of the belt-shaped material, the distance for loading with the heat-treatment temperature (that is, an oven length), the (mean) thickness of the belt-shaped material, the heat conduction or the heat transition to the belt-shaped material and/or the type of the selected alloy as well as parameters of the optionally providable magnetic field.

Since these parameters in practice can never be kept constant, the adjustment of the tensile stress, i.e., a force that can be adjusted variably in the process, can be used to keep the induced anisotropy K_{U} constant and thus to keep the permeability μ constant over the belt length. To this end, the force is varied in the belt, for example in small steps, to form a nominal tensile stress value to compensate for the local influences, such as temperature differences, belt thickness fluctuations, slight deviations of the throughput speed, changes in the material composition, etc.

Thus, for example, by means of adjusting the tensile force based on a determined magnetic measurement value for setting a desired tensile stress, the induced anisotropy K_{U} and thus the permeability can be kept constant over a defined section or even over the overall length of the belt-shaped material.

If the tensile stress is kept constant or constantly changed only in places by means of the described adjustment, this also opens up the possibility, by changing a corresponding preset value, of keeping constant the tensile stress in a first section to a first value and in a subsequent second section to a second value. Of course, more than two sections can also be provided with a constant tensile stress value that is set individually in each case. Then, for example, each section can be used for winding an individual magnetic core, and thus magnetic cores with different magnetic properties are produced in succession.

For example, the adjustment of the tensile force comprises an automatic setting of the tensile stress by a predefined nominal tensile stress value. The tensile force that is introduced into the belt-shaped material can thus be varied automatically in small steps or infinitesimally by the nominal tensile stress value in reaction to the at least one magnetic measurement value to compensate for local influences in the belt-shaped material, such as, for example, temperature differences, belt thickness fluctuations, deviations of the throughput speed, and/or changes in the material composition.

For example, the tensile force is continuously adjusted, i.e., a constant checking and (re-)adjustment are carried out. A predefined nominal value can, as described above, also be provided only for a defined section of the belt-shaped material, so that one or more sections in succession can be assigned individual tensile stress levels in each case, by which the induced anisotropy or the thus achieved permeability can be set specifically in a wide range over the length of the respective section.

Thus, based on a selected material composition of the belt-shaped material or an alloy that is used for this purpose, a permeability μ can be achieved in the range of 100 to 1,500 that is provided according to the invention. A permeability μ in this range is advantageous, for example, in the case of interphase transformers.

The embodiments that are described thus offer the advantage that a combination of the two aspects above, namely to be able to keep the tensile stress constant over a wide range as well as to preset a tensile stress level in places by a respective nominal tensile stress value, is made possible. It is not sufficient, for example, to introduce only a high tensile force into the belt-shaped material in order to achieve the desired permeability, since the achieved target permeability thus would be set exactly only for a specific local range of the belt-shaped material. Rather, in addition to the defined tensile force level, very fine and primarily smooth tensile force variations must be able to be designed in order to be able to keep the tensile stress, as described, to a constant value.

In other words, with the described method, soft-magnetic strip material can be produced with one or more different permeability levels that are constant in each case or with continuously changing permeability, whereby each level—by means of the adjustment according to the invention—can be produced with very slight deviations from the preset nominal permeability value over the entire strip length or over one or more defined sections.

Also, as an optional step, the method can comprise the loading of the belt-shaped material with a magnetic field (magnetic field treatment), whereby the magnetic field treatment can take place, for example, subsequent to or simultaneously with the heat treatment. Of course, a treatment can also be provided with more than one magnetic field, such as, for example, several magnetic fields with a different spatial orientation in each case.

The method comprises a step of winding up at least one defined section of the soft-magnetic strip material being produced for producing at least one magnetic core subsequent to the step of determining the at least one magnetic measurement value. By the step of winding-up, the magnetic core according to the invention is obtained as an annular belt core.

The strip material that is produced is thus wound up in connection to the above-described steps to form one or more annular belt cores. Since, by means of the described method, as constant or continuous a permeability plot as possible is produced on one or more levels, magnetic cores with in each case a very constant permeability distribution can be produced within the magnetic core but also with low sample scattering of several magnetic cores with the same nominal value for the permeability.

Improved magnetic cores can be produced with use of the improved method with very low sample scattering of less than +/−2.5%. Based on this, the magnetic cores according to the invention can be sized accurately, which relative to the state of the art produces a clear weight reduction of up to 50%. The magnetic cores that are produced according to the state of the art have a considerably higher sample scattering of up to +/−20%. This high tolerance must be preserved in the sizing, thus leading in turn to larger dimensions and higher core weights.

For example, the step of winding-up can be controlled in reaction to the at least one magnetic measurement value. This makes possible, for example, a specific winding-up by defined steps, which are determined via a characterization by means of the determined magnetic measurement value. If, for example, a different permeability level is thus reached, a jump in the permeability plot is thus detected or produced so the winding-up can be correspondingly controlled. Thus, for example, the winding-up of a first magnetic core can be completed, and a winding-up of a new magnetic core can be begun.

According to another embodiment, the step of the winding-up comprises a winding-up of a defined number of belt layers of the soft-magnetic strip material being produced for producing at least one annular belt core, whereby a defining of the number of belt layers is carried out in reaction to the at least one magnetic measurement value. To this end, for example, the local belt thickness or the associated magnetic cross-sectional surface area is taken into consideration for the step of winding-up. Even before the actual winding-up, a number of belt layers can be determined and can be varied within the framework of the winding-up, in such a way that the wound core has a predefined core cross-sectional surface area A_{KFe}.

The described method consequently offers the possibility of producing a number of magnetic cores, whereby each of the magnetic cores, in addition to a defined permeability plot over the length of the wound-up strip material, also has a defined core cross-section with a core cross-sectional surface area.

Thus, the belt shape makes possible not only a processing of the alloy under tensile stress in a continuous annealing unit described in more detail below, but rather also the production of annular belt cores with any number of windings. In this way, the size and the magnetic properties of an annular belt core can be matched in a simple way, by a corresponding selection of the number of windings or belt layers, to an application that is provided.

For example, in this connection, the number of belt layers can be varied in such a way that a cross-sectional surface area A_{KFe1} of a first annular belt core and a cross-sectional surface area A_{KFe2} of a second annular belt core are essentially equally large. Thus, any number of annular belt cores with equally large core cross-sectional surface areas in each case can be produced, at least, however, with a very low deviation of the respective core cross-sectional surface area. The number of belt layers can also be varied, for example, in such a way that as an alternative or in addition, the permeability of the first annular belt core and the permeability of the second annular belt core are essentially equally large.

Thus, the effect of the permeability that is constant at least in places and the effect of an equally large core cross-sectional surface area can be supported by an averaging process when the respective core is wound up. By means of this superposition when being wound up, the respective positive and negative deviations from a predefined nominal value are compensated for over a defined length (for example, several meters) of the strip material. Thus, in a single associated production method or process, a completely examined core with very low sample scattering relative to permeability and core cross-sectional surface area can be produced from a starting material, via a heat treatment up to a magnetic core production. In this way, narrow core tolerances are made possible, so that smaller magnetic cores can be produced, which in turn contribute to a savings in materials and cost.

The special importance of the magnetic measurement values that are measured in the soft-magnetic strip material that is produced for the magnetic cores then wound up therefrom and the respectively low sample scattering achieved with this are explained in more detail below.

Usually, the heat-treatment temperature and a throughput speed of the belt-shaped material based on the alloy that is selected in each case are selected in such a way that a magnetostriction in a nanocrystalline state of the corresponding heat-treated soft-magnetic strip material lies under 2 ppm. This can be viewed as a basic condition in order to wind a magnetic core from the heat-treated soft-magnetic strip material, which core, even after the winding process, has—in its wound-up state—a permeability that is similar to or even the same as the unwound strip material. This lies in the fact that a product of bending stresses owing to the winding-up and the value of magnetostriction represents an additional anisotropy induced in the strip material and therefore must be kept as small as possible. If this cannot be achieved, in any case the permeability of the wound core would more or less greatly differ from that of the strip material.

In addition, it can be stated that an anisotropy that is as high as possible and that is induced in the production method of the soft-magnetic strip material has the effect of the core being increasingly insensitive to the always unchanged, small additional anisotropies owing to the winding stresses. A corresponding comparison of a hysteresis measured on unwound soft-magnetic strip material and a hysteresis specific to the wound annular belt core is shown in FIG. 4.

As already mentioned, the belt-shaped material that is prepared within the framework of the described method as starting material can be heat-treated under tensile stress in order to produce the desired magnetic properties. In this connection, the selected temperature is of great importance, since based on the latter, the structure of the material is influenced. In this case, the heat-treatment temperature can lie above a crystallization temperature of the belt-shaped material for converting the belt-shaped material from the amorphous state into the nanocrystalline state. The nanocrystalline state is advantageous for the annular belt cores and responsible for excellent soft-magnetic properties of the strip material that is produced. Thus, a low saturation magnetostriction in the case of simultaneously higher saturation polarization is achieved by the nanocrystalline structure. By the proposed heat treatment under defined tensile stress, a magnetic hysteresis with a central linear part results with suitable alloy selection. Associated with this are low magnetization reversal losses and a permeability independent of the applied magnetic field or of the preliminary magnetization in the linear central part of the hysteresis within wide limits, which are desired in the case of magnetic cores in particular for current transformers. According to the invention, the heat treatment is carried out at a heat-treatment temperature of between 450 and 750° C.

According to an embodiment of the method according to the invention, the determination of at least one magnetic measurement value is carried out in real time. In this case, it is possible to perform a magnetic characterization “inline” within a production line in continuous operation. By way of example, a selection of magnetic measurement values is described in more detail below.

In this manner, it is possible that the belt-shaped material or the soft-magnetic strip material that is produced passes through a production device at full speed without having to interrupt or to slow down the process for the determination.

For example, the at least one magnetic measurement value can be selected from a group that consists of the magnetic saturation flux, the magnetic belt cross-sectional surface area A_{Fe}, the anisotropy field strength, the permeability, the coercive field strength, and the remanence ratio of the soft-magnetic strip material produced. It is common to all of these measurement values or the related magnetic properties of the strip material produced that the latter are based on a tensile stress that is introduced into the material and thus can be correspondingly adjusted by means of the described method.

If the step of determining the magnetic measurement value also comprises determining the local magnetic cross-sectional surface area A_{Fe}, this allows the production of not only a soft-magnetic strip material, which, as described, has as constant a permeability plot as possible along its length, but rather, moreover, simultaneously allows information on the thickness plot of the strip material produced to be obtained. This combination makes it possible to wind annular belt cores from the strip material produced with very precisely adjustable permeability values and simultaneously settable core cross-sectional surface areas A_{KFe} of the annular belt core by a necessary strip length already being able to be defined before the actual winding-up.

For implementing the improved method, a device for producing soft-magnetic strip material can be provided with an entry-side material feed for preparing belt-shaped material,

a heat-treatment device for heat-treating belt-shaped material at a heat-treatment temperature,

a tensioning device for loading the heat-treated belt-shaped material with a tensile force for producing a tensile stress in a belt longitudinal axis of the belt-shaped material at least in the area of the heat-treatment device,

a winding unit with at least one winding mandrel for winding up a defined section of the soft-magnetic strip material being produced for producing at least one magnetic core as an annular belt core,

whereby the tensioning device is designed in an adjustable manner for variation of the tensile force in the belt-shaped material in order to set the tensile stress,

whereby for producing the soft-magnetic strip material, in addition, the device comprises a measuring arrangement for determining at least one magnetic measurement value of the soft-magnetic strip material produced,

whereby an adjusting unit for adjusting the tensioning device is provided, which is designed and is connected to the measuring arrangement in such a way that the adjustment of the tensioning device comprises an adjustment of the tensile force in reaction to the at least one determined magnetic measurement value, and

whereby the winding unit is designed and connected to the measuring arrangement in such a way that the winding-up is carried out in reaction to the at least one determined measurement value.

The device can also comprise a device for producing at least one magnetic field for loading the heat-treated material with the at least one magnetic field being produced. The magnetic field can be oriented crosswise and/or perpendicular to the belt longitudinal axis or belt surface area.

For example, the tensioning device can be designed for producing the tensile force in the belt-shaped material in such a way that the belt-shaped material can nevertheless move along continuously, and the tensile force can be varied according to the preset value of the adjustment unit based on the magnetic measurement value determined by the measuring arrangement. For example, the tensioning device must be able to introduce a tensile force that is high enough into the belt-shaped material and to ensure a necessary accuracy to allow, for example, reproducible changes in tensile force and to be able to apply and to ensure the specified tensile force even with a plastic expansion of the belt-shaped material.

In this connection, the tensioning device for producing the tensile force comprises two S-shaped roller drives that are coupled to one another, a dancer adjustment and/or an oscillator adjustment as well as torque-controlled brake drives and/or mechanically braked rollers. Of course, other suitable tensioning devices can also be used, however, which fulfill the above-mentioned requirements.

For example, the belt-shaped material that is prepared by means of the entry-side material feed comprises a material that is cut to an end width and/or cast, belt-shaped, and/or wound up to form a coil. By means of such a premanufacturing, a simple processing in a heat-treatment device, such as, for example, a continuous annealing unit, is possible.

For example, the measuring arrangement is arranged in a section behind the heat-treatment device and/or the tensioning device, such that the soft-magnetic strip material passing through the measuring arrangement being produced is free of the tensile force provided by the tensioning device. Nevertheless, for transport and winding of the strip material, a specific tensioning or tensile force can be applied, of course.

By means of the improved method, the improved magnetic core can be produced. According to one embodiment, the soft-magnetic strip material can be coated with an insulating layer in order to insulate the windings of the annular belt core electrically from one another. In this case, the strip material can be coated with the insulating layer before and/or after the winding-up to form the magnetic core.

Of course, the above-mentioned features, and the features that are still to be explained below can be used not only in the combination indicated in each case, but rather also in any other suitable combinations or in a stand-alone fashion.

Also, the improved magnetic core can be used in particular for an interphase transformer. Such an interphase transformer can advantageously be used in particular in aircraft, for example the appropriate engine controllers.

It can still be noted that magnetic cores for interphase transformers can be obtained that have a low weight and a small volume and can be produced economically if (i) a described nanocrystalline alloy with a magnetostriction of less than 2 ppm is used, whose permeability, which is, for example, between μ=100 and 1,500, is specifically set by heat treatment of the alloy under a tensile stress of 30 MPa to 500 MPa, and (ii) the scatter of the magnetic values is reduced in particular by the described inline adjustment in the heat treatment. The smaller scattering makes possible an accurate optimization of the core dimensions, with which a significant reduction of the core weight is possible. The temperature dependency of the magnetic property of the improved magnetic core can ultimately be reduced (iii) by a reduction of the Nb content under 2 at. % (at %).

### BRIEF DESCRIPTION OF DRAWINGS

The invention is explained in more detail below based on the embodiments that are not limited to the invention, with reference to the drawings. In this case,

FIG. 1 shows, in a diagrammatic depiction, the course of the improved method according to a first embodiment,

FIG. 2 shows, in diagrammatic depiction, an exemplary embodiment of a device for implementing the improved method,

FIGS. 3A and 3B show principles of the tensile-stress-induced anisotropy, definitions of the mechanical and magnetic terms, and, in two diagrams, the connection between a tensile stress that is introduced into a belt-shaped material and a resulting anisotropy or permeability; FIGS. 3A and 3B show the connection between a tensile stress introduced into a belt-shaped material by means of a tensile force F and a resulting anisotropy Kᵤ or permeability M.

FIG. 4 shows, in a diagram, a comparison of a hysteresis that is measured on an unwound soft-magnetic strip material to a hysteresis that is determined on a wound core,

FIG. 5 shows, in a diagrammatic perspective sectional view, an embodiment of a magnetic core according to the invention;

FIG. 6 shows, in a diagram, the magnetization curve of an improved magnetic core at room temperature;

FIG. 7 shows, in a diagram, the temperature dependency of the anisotropy field strength Hₐ of the magnetic core according to the invention; and

FIG. 8 shows, in a diagram, the temperature dependency of the permeability μ of the magnetic core according to the invention.

### DETAILED DESCRIPTION OF SPECIFIC EMBODIMENTS

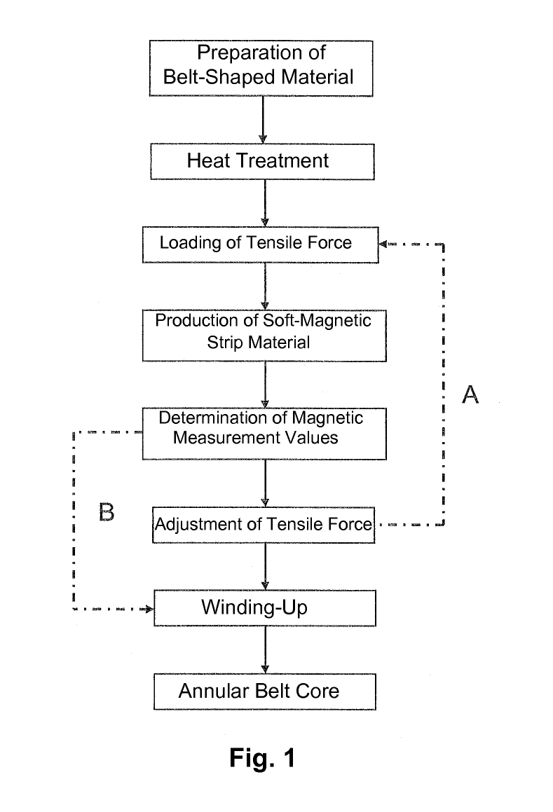

FIG. 1 diagrammatically shows an exemplary course of the improved method for the production of improved magnetic cores in the form of annular belt cores. The method comprises the preparation of a belt-shaped material, the heat treatment of the belt-shaped material at a heat-treatment temperature, and the loading of the heat-treated belt-shaped material with a tensile force in a longitudinal direction of the belt-shaped material in order to produce a tensile stress in the belt-shaped material. These steps are used to produce the soft-magnetic strip material from the belt-shaped material. In addition, the method comprises a determination of at least one magnetic measurement value of the soft-magnetic strip material produced and an adjustment of the tensile force for setting the tensile stress in reaction to the determined magnetic measurement value (arrow A). Also, the method comprises one step of winding up at least one defined section of the soft-magnetic strip material being produced for producing at least one annular belt core subsequent to the step of determining at least one magnetic measurement value. For example, the step of winding-up is controlled or adjusted in reaction to the at least one magnetic measurement value (arrow B).

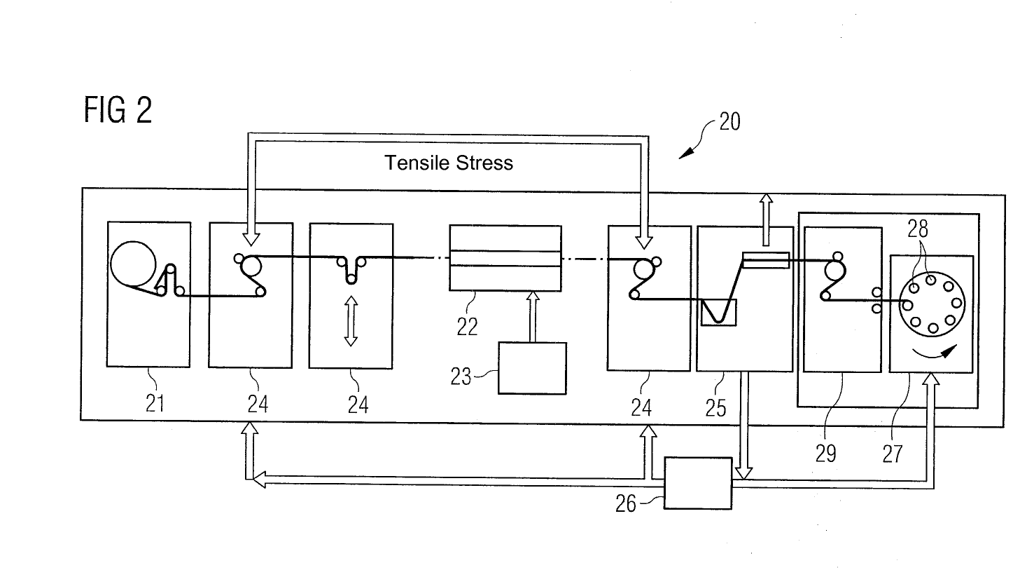

In a diagrammatic visualization, FIG. 2 shows an improved device 20 for the production of soft-magnetic strip material. The device 20 comprises an entry-side material feed 21 for preparing belt-shaped material, a heat-treatment device 22 for heat treatment of the belt-shaped material at a heat-treatment temperature, a tensioning device 24 for loading the belt-shaped material with a tensile force for preparing a tensile stress in a belt longitudinal axis of the belt-shaped material at least in the area of the heat-treatment device 22. The tensioning device 24 is designed to be adjustable for a variation of the tensile force in the belt-shaped material in order to set the desired tensile stress for producing soft-magnetic strip material.

In addition, the device 20 comprises a measuring arrangement 25 for determining at least one magnetic measurement value of the soft-magnetic strip material produced and an adjusting unit 26 for adjusting the tensioning device 24, whereby the adjusting unit 26 is designed and connected to the measuring arrangement 25 in such a way that the adjustment of the tensioning device 24 comprises an adjustment of the tensile force in reaction to the at least one determined magnetic measurement value. In the depicted embodiment, the tensioning device 24 comprises two S-shaped roller drives that are coupled to one another as well as a dancer adjustment. In addition to or as an alternative, the roller drives also have different speeds, whereby the first roller drive in the direction of movement of the belt can have a slightly lower running speed than the subsequent roller drive, by which then an additional tensile force can be produced between both roller drives. As an alternative, the first roller in this case can also be braked instead of driven. Except for the production of tensile force, the dancer adjustment can be used to compensate for speed fluctuations. As an alternative or in addition, an oscillator adjustment can be provided.

The device 20 also comprises a winding unit 27 with several winding mandrels 28 for winding up in each case a defined section of the soft-magnetic strip material being produced for producing a number of annular belt cores, whereby the winding unit is designed and is connected to the measuring arrangement 25 in such a way that the winding-up is carried out in reaction to the at least one determined measurement value. The winding unit 27 can optionally comprise an additional S-shaped roller drive 29 for feeding the strip material to the respective winding mandrel 28.

The device 20 optionally comprises a device 23 for producing at least one magnetic field for loading the heat-treated belt material with the at least one magnetic field.

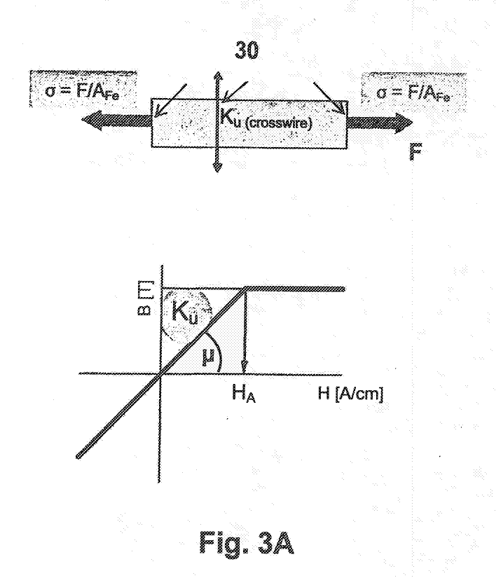

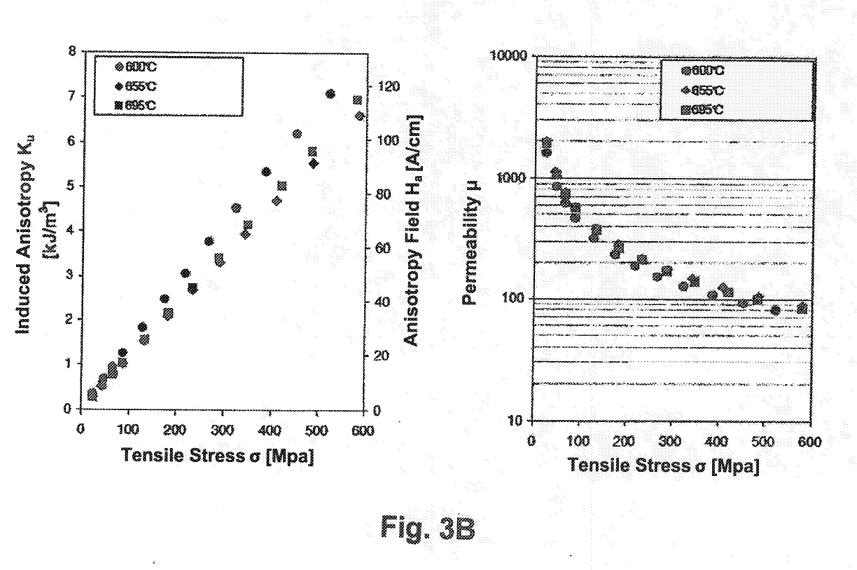

FIG. 3A and FIG. 3B show the connection between a tensile stress introduced into a belt-shaped material 30 by means of a tensile force F and a resulting anisotropy K_{U} or permeability μ. A local tensile stress σ that prevails in the belt-shaped material 30 is produced from the applied tensile force F and a local magnetic cross-sectional surface area A_{Fe} (material cross-section) to form:

$$σ = \frac{F}{{A}_{Fe}} \qquad ( 2 )$$

so that an induced anisotropy K_{U} in crosswise direction to the longitudinally-extended belt-shaped material increases based on the tensile stress σ according to the diagram depicted in FIG. 3B. A permeability μ is set via the applied tensile stress σ and is produced, as is known, from the mean slope of the hysteresis loop or from a magnetic flux density Bₛ (saturation magnetization) or a magnetic field strength H (anisotropy field strength Hₐ) as well as a magnetic field constant μₒ in connection to the anisotropy K_{U} as follows:

$$μ = \frac{1}{2} \frac{{B}_{S}^{2}}{{μ}_{o} {K}_{U}} \qquad ( 3 )$$

Thus, for example, if a fluctuating thickness of the belt-shaped material exists, due to production-related factors, assuming an unchanged width, the local cross-sectional surface area A correspondingly fluctuates, and with it, at constant tensile force F, the applied tensile stress σ. The latter in turn produces a corresponding change in the induced anisotropy K_{U}, which correspondingly influences the permeability μ via the above-mentioned connections, so that the latter also varies over the length of the soft-magnetic strip material thus produced from the belt-shaped material.

In addition, FIG. 3B shows the plot of the permeability based on the tensile stress a for three heat-treatment temperatures.

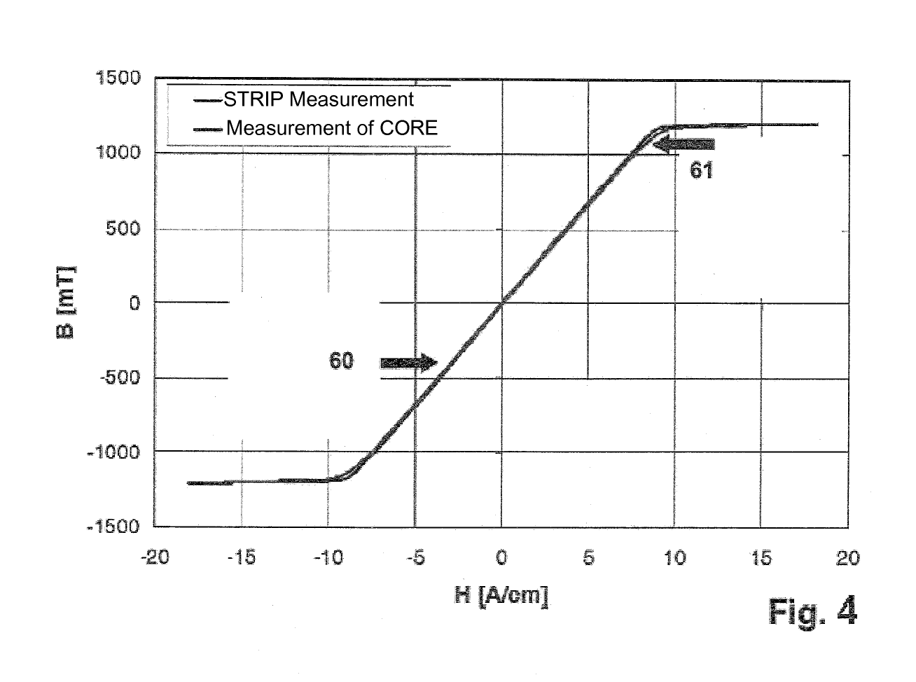

FIG. 4 shows a comparison of a hysteresis 60 measured on unwound soft-magnetic strip material and a hysteresis 61 determined on the wound core. In order to create a wound-up annular belt core, which has as similar as possible or even the same permeability as the strip material, from the unwound soft-magnetic strip material according to the method of the invention, the heat-treatment temperature and a throughput speed should be matched based on a selected material or a selected alloy in such a way that a magnetostriction lies below 2 ppm in a nanocrystalline state of the strip material.

Owing to the winding-up of the strip material and the value of the magnetostriction, the product of bending stresses represents an additional anisotropy induced in the wound-up strip material and should therefore be kept as small as possible. Otherwise, the permeability of the magnetic core would differ more or less greatly from that of the unwound strip material. It thus holds true that the higher the anisotropy induced when the unwound soft-magnetic strip material is produced, the less sensitive the annular belt core is to the invariant small additional anisotropies due to the winding stresses.

As can be seen from the depicted hysteresis plot, a permeability μ lies in a range of 1,000. This corresponds to a low- to medium-strength induced anisotropy. Except for small defects in a range of a discharge point into a magnetic saturation, the two hysteresis plots can be seen as identical for the unwound soft-magnetic strip material 60 and the wound-up annular belt core 61.

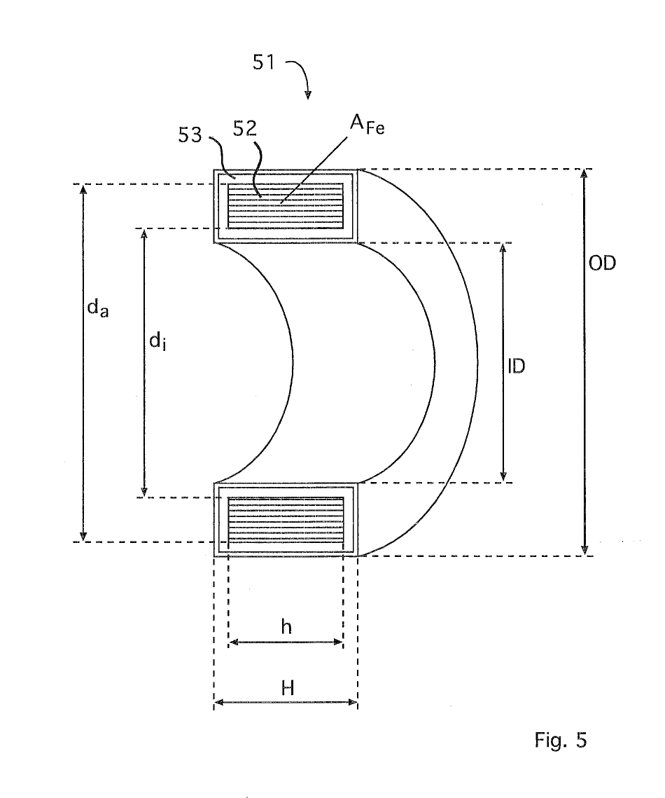

FIG. 5 shows a section through a magnetic core 51 according to the invention, which has a wound annular belt core 52 and a coating 53 that consists of a powder coating. The coating 53 attaches to the annular belt core 52. Such a fixing makes possible a size reduction of the magnetic core. In this invention, such a fixing is possible despite the mechanical stresses introduced here, since the magnetic cores have a small magnetostriction.

The annular belt core 52 has a height h, an outside diameter dₐ, and an inside diameter dᵢ. The powder coating layer 53 is applied on the surfaces of the annular belt core. The magnetic core 51 has a height H, an outside diameter OD, and an inside diameter ID, whereby the belt has a belt cross-sectional surface area A_{Fe}.

Below, comparison examples are contrasted to examples according to the invention. For this purpose, magnetic cores were produced, whose composition is indicated in Table 1 together with the production method and magnetization reversal losses.

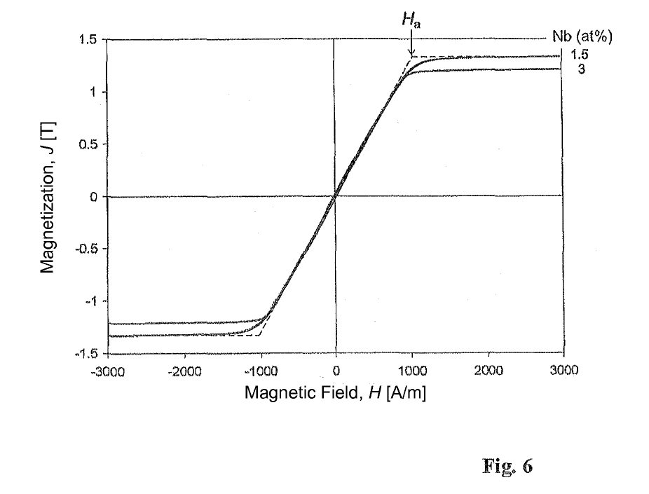

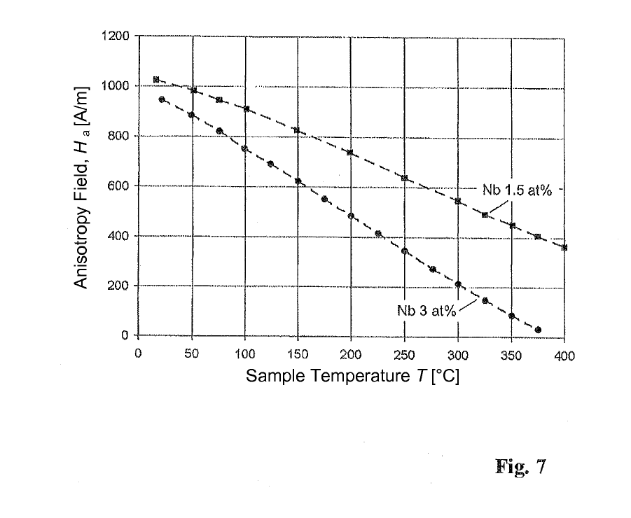

In FIGS. 6, 7 and 8, diagrams are shown that represent properties of Examples 1 and 2 according to the invention (below, also, only examples are mentioned). In FIG. 6, the notation “Nb (at. %) 3” characterizes Example 1, and the notation “Nb (at. %) 1.5” characterizes Example 2. In FIGS. 7 and 9, the notation “Nb 3 at. %” characterizes Example 1, and the notation “Nb 1.5 at. %” characterizes Example 2. The monitored magnetic value in Examples 1 and 2 was the permeability μ or—equivalent thereto—the anisotropy field strength H_{A}.

Comparison Example 1 shows the magnetization reversal losses for a non-oriented electric sheet in 0.35 mm sheet thickness.

Comparison Example 2 shows the amorphous alloy Co_{72.5}Fe_{1.5}Mn₄Si₅B₁₇ (notations in at. % (at %)), which is commercially available under the trade name VITROVAC 6150 in belt thicknesses of approximately 20 μm. In Comparison Example 2, the material was wound into an annular belt core and then heat-treated for 1 hour at 360° C. in a magnetic field crosswise to the magnetization direction. Thus, a linear hysteresis loop is produced, which has a permeability of μ=1,000 up to a magnetic field strength of approximately 800 A/m, before the material is magnetically saturated. This material has less than one-hundredth of the losses of the electric sheet and would therefore be suitable for use for interphase transformers. However, the magnetic properties are thermally stable only up to a maximum operating temperature of approximately 100° C. to 120° C., whereby the requirements of the application to the operating temperature are not met.

Comparison Example 3 is a nanocrystalline alloy of the composition Fe₇₄Cu₁Nb₃Si_{15.5}B_{6.5} (notations in at. %), which as VITROPERM 800 is commercially available as approximately 20 μm thin metal foil. The material is produced as an originally amorphous belt, wound on a core, and then converted by an at least ten-minute heat treatment between 500° C. and 600° C. into the nanocrystalline state. In Comparison Example 3, it was also heat-treated in a magnetic field crosswise to the magnetization direction. In this connection, a linear hysteresis loop is produced, which has a permeability of μ=25,000 up to a magnetic field strength of approximately 35 A/m, before the material is magnetically saturated. Comparison Example 3 shows small losses similar to Comparison Example 2 and is therefore suitable for use for an interphase transformer per se. Another advantage of the nanocrystalline alloy is an elevated thermal stability, which allows a maximum operating temperature of up to approximately 180° C. Another advantage of Comparison Example 3 is that the material consists of economical raw materials in contrast to Comparison Example 2, which contains large portions of Co and therefore relatively high raw material costs. It is disadvantageous with respect to the use for an interphase transformer, however, that the magnetic core according to Comparison Example 3 is already saturated in relatively small magnetic fields.

The last-mentioned drawback can be eliminated, according to the invention, when the material is heat-treated not in a magnetic field, but rather in passing under tensile stress, and the thus heat-treated belt is then wound into an annular belt core. In this connection, if a tensile stress of 50 MPa is selected, a flat loop is produced, which has a permeability of μ=1,000 up to a field of approximately 1,000 A/m. FIG. 6 shows the magnetization curve of Examples 1 and 2 according to the invention, indicated in Table 1. As can be seen from Table 1, very small losses also occur here. The material that is heat-treated under tensile stress also has a still better thermal stability than the material that is heat-treated in the magnetic field. Therefore, continuous operating temperatures of up to 200° C. and even more are easily possible with the materials according to the invention. By way of example, FIG. 6 shows the definition of the anisotropy field strength Hₐ relative to Example 2.

In comparison to Example 1, Example 2 specifically has somewhat higher losses, but in comparison to Example 1 with 1.34 T, it has a saturation induction that is higher by 10%. By increasing the saturation magnetization, the magnetic core can be scaled-down, and its weight can be reduced. This is possible since owing to the higher saturation, the permeability can be increased, without the magnetic core going into saturation prematurely. In addition to saving weight, the core can also be produced more economically due to the lower Nb content.

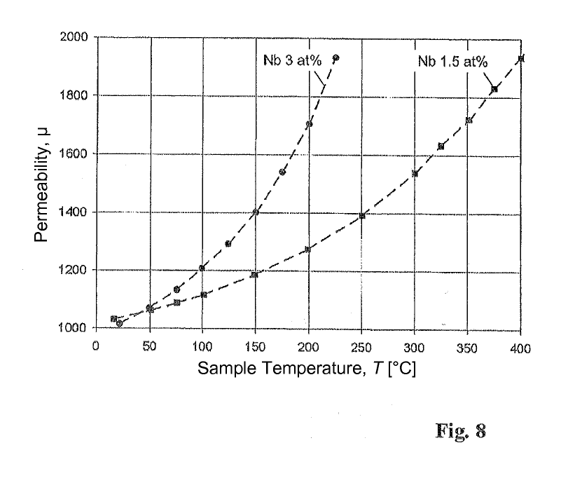

A still weightier advantage is the low temperature dependency of the permeability and the anisotropy field strength, in which the material goes into saturation. The corresponding behavior is shown in FIGS. 7 and 8. It is seen that the anisotropy field and permeability are changed up to an operating temperature of 150° C. by less than 50% of the room temperature value. An especially advantageous behavior can be seen for Example 2, which is distinguished by an Nb content of less than 2 at. %. Here, the change from the anisotropy field and permeability up to an operating temperature of 200° C. is even less than 30% of the room temperature value.

Annular belt cores with an outside diameter dₐ of 141 mm and an inside diameter d, of 106 mm in a core height h of 42.7 mm were produced from the material manufactured according to Examples 1 and 2 (see FIG. 5). To this end, 7 cores with a 6.1 mm-wide belt were produced by means of the method according to the invention, saturated with resin, stacked over one another, and then cast in plastic.

Since in such a fixing of the magnetic core, inner mechanical stresses occur, the magnetostriction constants of the material should lie considerably below 2 ppm so that the fixing does not impair the magnetic properties of the magnetic core. The existing Examples 1 and 2 therefore have a saturation magnetostriction of less than 0.5 ppm.

In the core geometry shown in FIG. 5, in the case of an anisotropy field of Hₐ=1,000 A/m (cf. FIG. 6) with a Cu-winding, peak currents of up to 300 A are possible, without the magnetic core being magnetically saturated. In the case of N Cu-windings, peak currents of up to 300/N ampere are correspondingly possible. These peak currents that can be tolerated can be, e.g., easily doubled by having the material be heat-treated under tensile stresses that are twice as high (i.e., approximately 100 MPa). If heat treatment is done under a tensile stress of 500 MPa, peak currents that are ten times as high correspondingly can be tolerated.

TABLE 1
Magnetization Reversal Losses of Exemplary Materials

| | | | Losses |
|---|---|---|---|
| | | | in W/kg |
| | | | (B = 0.5 T, |
| | Composition (at. %) | Description | 5 kHz) |
| CE 1 | Fe—Si 3.2% | Commercially | 280 |
| | by Weight of NO | Available Electric | |
| | | Sheet | |
| CE 2 | Co_{72.5}Fe_{1.5}Mn₄Si₅B₁₇ | Amorphous Metal | 1.4 |
| | | Belt Heat-Treated in | |
| | | the Magnetic Field | |
| CE 3 | Fe₇₄Cu₁Nb₃Si_{15.5}B_{6.5} | Nanocrystalline | 1.5 |
| | | Material Heat- | |
| | | Treated in the | |
| | | Magnetic Field | |
| Ex. 1 | Fe₇₄Cu₁Nb₃Si_{15.5}B_{6.5} | Nanocrystalline | 3.3 |
| | | Heat-Treated for | |
| | | 15 s at 680° C. under | |
| | | Tensile Stress of | |
| | | Approximately 50 MPa | |
| Ex. 2 | Fe_{75.5}Cu₁Nb_{1.5}Si_{15.5}B_{6.5} | Nanocrystalline | 5.2 |
| | | Heat-Treated for | |
| | | 15 s at 660° C. under | |
| | | Tensile Stress of | |
| | | Approximately 50 MPa | |

CE = Comparison Example,
Ex. = Example According to the Invention

Improved magnetic cores with very low sample scattering of less than +/−2.5 can thus be produced. Because of the improved production method with use of inline adjustment, the improved magnetic cores can be sized accurately, which produces a considerable weight reduction of up to 50% relative to the state of the art. The magnetic cores that are produced according to the state of the art have a considerably higher exemplary scattering of up to +/−20%. This high tolerance must be preserved in the sizing, thus leading in turn to larger dimensions and higher core weights. For example, cores with a core geometry of 18.7×23×6.1 mm were produced from VITROPERM 800 according to the improved method with the target values μ=1,000 and Afe=10.8 mm². In this case, 236 cores were evaluated in series. The desired permeability was achieved with a standard deviation of 8.6 (0.86%), whereby absolute dμ/μₛₑₜₚₒᵢₙₜ lies in the range of +/−2.0%, and the mean of μ lies at 999.2. The Fe cross-section was achieved with a standard deviation of 0.06 (0.55%), absolute yields dAFe/AFeₛₑₜₚₒᵢₙₜ were in the range of +/−1.2%; the mean of AFe lies at 10.82 mm².

1. A magnetic core comprising a nanocrystalline alloy, which consists of Fe_{100-a-b-c-d-x-y-z}CuₐNb_{b}M_{c}T_{d}SiₓB_{y}Z_{z} and up to 1 at. % of impurities, whereby M is one or more of the elements Mo, Ta or Zr; T is one or more of the elements V, Cr, Co or Ni; and Z is one or more of the elements C, P or Ge, and
0 at. %≦a<1.5 at. %,
0 at. %≦b<4 at. %,
0 at. %≦c<4 at. %,
0 at. %≦d<5 at. %,
12 at. %<x<18 at. %,
5 at. %<y<12 at. %, and
0 at. %≦z<2 at. %,
wherein the magnetic core has a saturation magnetostriction of less than 2 ppm and a permeability of between 100 and 1,500, and wherein the alloy has been exposed to a heat treatment at a heat-treatment temperature of between 450 and 750° C. under a tensile stress of between 30 and 500 MPa.

2. The magnetic core according to claim 1, wherein the nanocrystalline alloy has a nanocrystalline structure with a crystalline phase, which is embedded in an amorphous matrix, wherein the crystalline phase consists of bcc Fe—Si and has a volume proportion of greater than 50%.

3. The magnetic core according to claim 2, wherein the crystalline phase comprises grains having a grain diameter of less than 100 nm.

4. The magnetic core according to claim 1, which has a saturation magnetization of greater than 1.1 Tesla.

5. The magnetic core according to claim 1, in which the alloy has an anisotropy field strength, in which it is saturated, of at least 600 A/m.

6. The magnetic core according to claim 1, which has magnetization reversal losses of less than 20 W/kg with an excitation frequency of 5 kHz and an induction stroke of 0.5 T.

7. The magnetic core according to claim 1, in which in a temperature range from room temperature up to 150° C., an increase in permeability or a reduction of the anisotropy field strength is less than 50%, relative to the room temperature value.

8. The magnetic core according to claim 1, in which the alloy contains at most 2 at. % of niobium.

9. The magnetic core according to claim 1, in which in a temperature range from room temperature up to 200° C., an increase in permeability or a reduction in anisotropy field strength is less than 30%, relative to the room temperature value.

10. The magnetic core according to claim 1, in which 15 at. %≦x≦16.5 at. %.

11. The magnetic core according to claim 1, which has a saturation magnetostriction of less than 1 ppm.

12. A method for the production of a magnetic core with the steps:
preparing an alloy as a belt-shaped material, whereby the alloy consists of Fe_{100-a-b-c-d-x-y-z}CuₐNb_{b}M_{c}T_{d}SiₓB_{y}Z_{z} and up to 1 at. % of impurities, wherein M is one or more of the elements Mo, Ta or Zr; T is one or more of the elements V, Cr, Co or Ni; and Z is one or more of the elements C, P or Ge, and
0 at. %≦a<1.5 at. %,
0 at. %≦b<4 at. %,
0 at. %≦c<4 at. %,
0 at. %≦d<5 at. %,
12 at. %<x<18 at. %,
5 at. %<y<12 at. %, and
0 at. %≦z<2 at. %,
heat treating the belt-shaped material at a heat-treatment temperature of between 450 and 750° C.;
loading the heat-treated belt-shaped material with a tensile force in the longitudinal direction of the belt-shaped material in order to produce a tensile stress of between 30 MPa and 500 MPa in the belt-shaped material, to produce a soft-magnetic strip material from the belt-shaped material;
determining of at least one magnetic measurement value of the soft-magnetic strip material being produced, and
adjusting of the tensile force for setting the tensile stress in reaction to the determined magnetic measurement value; and
winding up at least one defined section of the soft-magnetic strip material being produced to produce the magnetic core.

13. The method according to claim 12, in which the at least one magnetic measurement value is selected from a group that consists of magnetic saturation flux, magnetic belt cross-sectional surface area, anisotropy field strength, permeability, coercive field strength, and remanence ratio of the soft-magnetic strip material produced.

14. The method according to claim 12, in which the step of winding up comprises a winding-up of a defined number of belt layers of the soft-magnetic strip material being produced in order to produce the magnetic core, and a defining of the number of belt layers in reaction to the at least one magnetic measurement value is carried out.

15. An interphase transformer comprising a magnetic core according to claim 1.
